(19) United States
(12) Patent Application Publication
(10) Pub. No.: US 2026/0281573 A1
(43) Pub. Date: Sep. 17, 2026

(54) CURRENT ASSISTED PHOTONIC DEMODULATOR (CAPD) IMAGE CAPTURE

(71) Applicant: QUALCOMM Incorporated, San Diego, CA (US)

(72) Inventors: Micha Galor Gluskin, San Diego, CA (US); Hung Pin Chou, New Taipei (TW)

(21) Appl. No.: 19/081,574

(22) Filed: Mar. 17, 2025

(51) Int. Cl. H04N 25/583; H04N 25/616; H04N 25/78

(52) U.S. Cl. CPC H04N 25/583; H04N 25/616; H04N 25/78

(57) ABSTRACT

An image sensor system for high dynamic range (HDR) imaging utilizes a current assisted photonic demodulator (CAPD) to address luminance capture challenges in varied lighting conditions. The system includes processing circuitry that modulates voltage at a CAPD sensor's modulation electrode with an adjustable duty cycle, allowing a first photodiode to have a longer integration time than a second photodiode. This configuration enables simultaneous capture of longer and shorter exposures.

### TECHNICAL FIELD

The disclosure relates to image processing including high dynamic range (HDR) image capture.

### BACKGROUND

Imaging techniques that capture a wide range of luminance levels, such as high dynamic range (HDR) imaging techniques, may be beneficial in environments with lighting variations, such as those with both bright sunlight and deep shadows. Traditional methods involve capturing multiple images at different exposure levels and combining them to create a single image that represents the full range of luminance.

### SUMMARY

The techniques of the disclosure include an apparatus and method for image processing using a current assisted photonic demodulator (CAPD) image sensor. Processing circuitry may be configured to modulate a voltage at a modulation electrode of the CAPD sensor using an adjustable duty cycle. In some examples, the adjustable duty cycle is an asymmetric duty cycle. The adjustable duty cycle may be configured to cause one photodiode of a pixel of the CAPD sensor to have a longer integration time relative to another photodiode of the same pixel, facilitating the capture of high dynamic range (HDR) images. The processing circuitry may be further configured to receive image data captured in the HDR mode, enabling the combination of longer and shorter exposure images to form an HDR image.

In other examples, the adjustable duty cycle may be generated by applying a random inverse phase function to the modulation voltage, which can enhance the flexibility and performance of the image capture process. The techniques of this disclosure may also include configurations where a diode is placed between the photodiodes of a pixel to block charge flow between the long and short photodiodes, reducing blooming effects. In other examples, this disclosure describes a configuration where adjacent pixels share the same readout trace to optimize sensor design. The benefits of these techniques include improved image quality with reduced blending artifacts, such as ghosting, efficient HDR image capture, and the potential for lower power consumption and cost due to the simplified sensor architecture.

In one example, this disclosure describes an apparatus configured to capture an image, the apparatus comprising a memory, and processing circuitry coupled to the memory, the processing circuitry configured to modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor, and receive image data for an image captured with the CAPD sensor.

In another example, this disclosure describes a method of capturing an image, the method comprising modulating a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor, and receiving image data for an image captured with the CAPD sensor.

In another example, this disclosure describes a non-transitory computer-readable storage medium storing instructions that, when executed, cause one or more processors of a device configured to capture an image to modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor, and receive image data for an image captured with the CAPD sensor.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 shows example readout times for three multi-frame HDR image capture techniques.

FIG. 3 is a block diagram of an example sensor module according to the techniques of this disclosure.

FIG. 4 is a circuit diagram showing an example pixel of a CAPD image sensor in accordance with the techniques of this disclosure.

FIG. 5 is a circuit diagram showing another example pixel of a CAPD image sensor in accordance with the techniques of this disclosure.

FIG. 6 shows an example readout time for the CAPD HDR technique of this disclosure.

FIG. 7 shows an example duty cycle for the CAPD HDR technique of this disclosure.

FIG. 8 shows another example duty cycle for the CAPD HDR technique of this disclosure.

FIG. 9 shows an example duty cycle with a random inverse phase function for the CAPD HDR technique of this disclosure.

FIG. 10 is a circuit diagram showing an HDR CAPD pixel with a random inverse phase function for the CAPD HDR technique of this disclosure.

FIG. 11 shows another example duty cycle with a random inverse phase function for the CAPD HDR technique of this disclosure.

FIG. 12 shows an example readout trace implementation in accordance with one example of the disclosure.

FIG. 13 illustrates a flow chart illustrating an example process for capturing an image using a CAPD HDR mode according to the techniques of this disclosure.

### DETAILED DESCRIPTION

HDR imaging is a technique used to capture a greater range of luminance levels in a scene than what is possible with standard digital imaging techniques. HDR imaging may be particularly useful in situations where there are significant variations in lighting, such as scenes with both bright sunlight and deep shadows. The primary challenge in HDR imaging is to accurately capture both the bright and dark areas of a scene without losing detail in either. Traditional methods involve capturing multiple images at different exposure levels and combining the multiple images to create a single image that represents the full range of luminance. However, this approach can lead to artifacts, particularly when there is motion in the scene, resulting in ghosting effects where moving objects appear blurred or duplicated.

Existing HDR imaging techniques often suffer from several disadvantages. One significant issue is the temporal mismatch between the longer and shorter exposures, which are captured at different times. This can lead to ghosting artifacts when the images are combined. Additionally, the blending algorithms used to merge the different exposures can struggle to accurately align and blend the images, especially in dynamic scenes. Another limitation is the increased complexity and cost associated with sensors that attempt to mitigate these issues by using more sensitive diodes or other hardware modifications. These solutions can also lead to increased power consumption and reduced image quality due to noise and other artifacts.

This disclosure describes devices and techniques that addresses these challenges by utilizing a CAPD image sensor to capture HDR images. A CAPD sensor is designed to split the accumulated charge between two photodiodes of a single pixel, allowing for simultaneous capture of two exposures. In accordance with the techniques of this disclosure, a modulation electrode of one or more pixels of a CAPD sensor may be modulated using an adjustable duty cycle, such that a first photodiode of a pixel of the CAPD sensor has a longer integration time relative to a second photodiode of the same pixel of the CAPD sensor. In some examples, the adjustable duty cycle is an asymmetric duty cycle. As such, the first photodiode of the pixel captures a longer exposure, while the second photodiode of the same pixel captures a shorter exposure at the same time. As such, both the longer exposure and the shorter exposure have the same blurring characteristics due to motion in the scene. This approach reduces the temporal mismatch and ghosting artifacts associated with traditional HDR techniques. The techniques of this disclosure may also result in a more accurate and efficient HDR image capture process, reducing the complexity and cost of the sensor while maintaining high image quality.

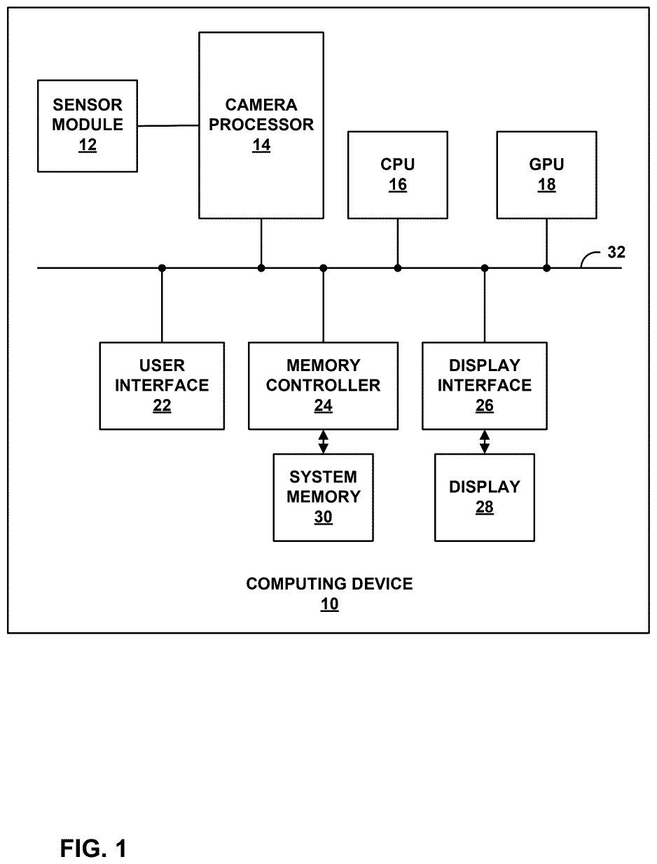

FIG. 1 is a block diagram of a device configured to perform one or more of the example techniques described in this disclosure for HDR image capture using a CAPD sensor. Examples of computing device 10 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 10 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 10 includes sensor module 12, a camera processor 14, a central processing unit (CPU) 16, a graphical processing unit (GPU) 18, user interface 22, memory controller 24 that provides access to system memory 30, and display interface 26 that outputs signals that cause graphical data to be displayed on display 28. Although FIG. 1 illustrates sensor module 12 as part of the same device that includes camera processor 14, CPU 16, and GPU 18, the techniques described in this disclosure are not so limited. In some examples, camera processor 14, CPU 16, and GPU 18 and many of the various other components illustrated in FIG. 1 may be on a different device (e.g., a processing device) than sensor module 12.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 14 may be external to computing device 10; however, it may be possible for camera processor 14 to be internal to computing device 10, as illustrated. For instance, in some examples, sensor module 12 and camera processor 14 may form a pluggable camera for a desktop or laptop computer, and CPU 16, GPU 18, and the various other components may be part of the desktop or laptop computer. For ease of description, the examples are described with respect to the configuration illustrated in FIG. 1.

Sensor module 12 includes an image sensor with a plurality of sensor elements (e.g., photodiodes) arranged in a two-dimensional array. The sensor elements (e.g., “pixels”) may be CMOS (Complementary Metal-Oxide-Semiconductor) elements. Each pixel generates an electrical signal based on a luminance of the light incident to the sensor element. With filtering, such as Bayer filtering, the electrical signals generated by each of the sensor element indicate the luminance of a particular color. In the examples of this disclosure, sensor module 12 may be configured as a CAPD image sensor, or more generally, a CAPD sensor.

CAPD sensors operate by utilizing an alternating voltage to create drift fields within the photodiode structure. CAPD technology is typically used in indirect Time of Flight (iToF) applications, where the CAPD sensor enhances the efficiency of light detection and distance measurement. iTOF is a technology used to measure distances by calculating the time it takes for light to travel from a source to an object and back to a sensor. Unlike direct ToF, which measures the time delay of a single light pulse, iTOF uses continuous wave (CW) modulation to emit light, and the phase shift between the emitted and reflected light is used to determine distance. This method allows for high precision and accuracy in distance measurement, making it ideal for applications such as 3D imaging, gesture recognition, and autonomous navigation.

iTOF systems typically employ a light source, such as a laser or LED, to emit modulated light towards a target. The reflected light is captured by a sensor, such as a CAPD sensor, which uses the phase difference between the emitted and received light to calculate the distance to the target. The use of CW modulation allows iTOF systems to achieve high sensitivity and resolution, even in challenging lighting conditions. This makes iTOF a popular choice for applications that require accurate depth perception and spatial awareness.

A CAPD sensor structure includes modulation electrodes that apply an alternating voltage, which generates an electric field within the photodiode. This field is responsible for directing the movement of photo-generated electrons towards the detection junctions, thereby improving the sensor's ability to capture and process light signals.

The CAPD sensor's operation is based on the principle of phase-shift detection. In a typical iToF application, a light source emits modulated light, which reflects off objects and returns to the sensor. The CAPD sensor samples this incoming light synchronously with the emitted light modulation. The alternating voltage within the sensor creates drift fields that divide and pull the electrons towards alternating detector junctions (e.g., two different photodiodes for the same pixel of the sensor). These junctions are 180 degrees out of phase, allowing the sensor to accurately capture the phase shift between the emitted and reflected light, which is used for calculating distance.

One of the key features of CAPD sensors is their ability to achieve high demodulation contrast and efficiency. The alternating drift fields within the sensor better ensure that electrons are quickly and effectively directed to the appropriate detection junctions based on their return time. This results in a high contrast ratio, which is helpful for more precise phase shift calculations.

The CAPD technology may be further enhanced through integration with backside illuminated CMOS technology. This integration better ensures that the maximum amount of light reaches the photodiode by placing the wiring layer below the photodiode, thus improving light sensitivity. This design minimizes any obstructions that might block incoming light, thereby reducing unwanted image artifacts such as smearing and blooming, which are common in traditional sensors.

In practical applications, CAPD sensors are capable of sampling incoming light with multiple phases for each depth frame. Each sample, or micro-frame, is phase-stepped by 90 degrees, with stages for reset, integration, and readout. This multi-phase sampling allows the sensor to effectively cancel out ambient light and other fluctuations, better ensuring accurate and reliable depth measurements. The CAPD's ability to handle multiple phases and its high-speed operation make it ideal for applications requiring precise distance and depth measurements.

In some examples, the pixels of the image sensor in sensor module 12 may be in a three transistor (3T) or a four transistor (4T) configuration. A 3T pixel configuration includes three primary transistors per pixel: a reset transistor (RST), a source follower transistor (SF), and a row select transistor (SEL). These components work together to capture and read out image signals with minimal complexity and power consumption. A 4T pixel configuration enhances the performance and functionality of image sensors by incorporating an additional transistor compared to the 3T configuration. The 4T pixel configuration includes four primary transistors per pixel: a reset transistor (RST), a source follower transistor (SF), a row select transistor (SEL), and a transfer gate transistor (TX). These components work together to capture and read out image signals with improved noise performance, higher dynamic range, and better image quality. The 4T pixel configuration may offer advantages over the 3T configuration, including improved noise performance, higher dynamic range, and reduced fixed pattern noise, resulting in clearer, more detailed, and more accurate images. Additionally, the 4T configuration may enable more efficient charge transfer and correlated double sampling (CDS), further enhancing image quality and sensor performance.

Camera processor 14 is configured to receive electrical signals as sensor signals from respective sensor elements of sensor module 12 and process the electrical signals to generate pixel data of an image frame. In some examples, camera processor 14 may be configured as a single-input-multiple-data (SIMD) architecture. Camera processor 14 may perform the same operations on electrical signals received from each of the sensor elements of sensor module 12. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels. As will be explained in more detail below, camera processor 14 may be configured to cause sensor module 12 to operate in an HDR capture in accordance with the techniques of this disclosure.

CPU 16 may comprise a general-purpose or a special-purpose processor that controls operation of computing device 10. A user may provide input to computing device 10 to cause CPU 16 to execute one or more software applications. The user may provide input to computing device 10 via one or more input devices (not shown) such as a keyboard, a mouse, a microphone, a touch pad or another input device that is coupled to computing device 10 via user interface 22. In some examples, a user may provide an input that causes sensor module 12 to capture images in the HDR capture mode of this disclosure.

One example of the software application is a camera application. CPU 16 executes the camera application, and in response, the camera application causes CPU 16 to generate content that display 28 outputs. For instance, display 28 may output information such as light intensity, whether flash is enabled, and other such information. The user of computing device 10 may interface with display 28 to configure the manner in which the images are generated (e.g., with or without flash, focus settings, exposure settings, and other parameters). The camera application also causes CPU 16 to instruct camera processor 14 to process the images captured by sensor module 12 in the user-defined manner.

As one example, the user interacting with the camera application may be considered as a start of a camera session, and the end of the camera session may be after the user takes the picture or exits the camera application. In examples where computing device 10 is a digital camera, the start of the camera session may be when the user turns on the digital camera to take a picture or video.

GPU 18 may generate graphical information that provides the user information about the image frames to be captured. For instance, GPU 18 may generate a graphic that indicates whether flash is enabled, generate boxes around identified faces, etc.

Memory controller 24 facilitates the transfer of data going into and out of system memory 30. For example, memory controller 24 may receive memory read and write commands, and service such commands with respect to system memory 30 in order to provide memory services for the components in computing device 10. Memory controller 24 is communicatively coupled to system memory 30. Although memory controller 24 is illustrated in the example of computing device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting images from camera processor 14, etc. System memory 30 may additionally store information for use by and/or generated by other components of computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 30 may include instructions that cause camera processor 14, CPU 16, GPU 18, and display interface 26 to perform the functions ascribed to these components in this disclosure. Accordingly, system memory 30 may be a computer-readable storage medium having instructions stored thereon that, when executed, cause one or more processors (e.g., camera processor 14, CPU 16, GPU 18, and display interface 26) to perform various functions.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

Camera processor 14, CPU 16, and GPU 18 may store image data, and the like in respective buffers that are allocated within system memory 30. Display interface 26 may retrieve the data from system memory 30 and configure display 28 to display the image represented by the generated image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, or another type of display unit. Display 28 may be integrated within computing device 10. For instance, display 28 may be a screen of a mobile telephone handset or a tablet computer. Alternatively, display 28 may be a stand-alone device coupled to computing device 10 via a wired or wireless communications link. For instance, display 28 may be a computer monitor or flat panel display connected to a personal computer via a cable or wireless link.

In one or more examples of the disclosure, sensor module 12 may be configured to operate in an HDR capture mode. In general, the HDR capture mode may include capturing both a longer exposure image and shorter exposure image, and combining those two images into a single HDR image. Traditional HDR methods involve capturing multiple images at different exposure levels and combining the multiple images to create a single image that represents the full range of luminance. Such techniques are often called multi-frame HDR image capture. However, multi-frame HDR image capture can lead to artifacts, particularly when there is motion in the scene, resulting in ghosting effects where moving objects appear blurred or duplicated.

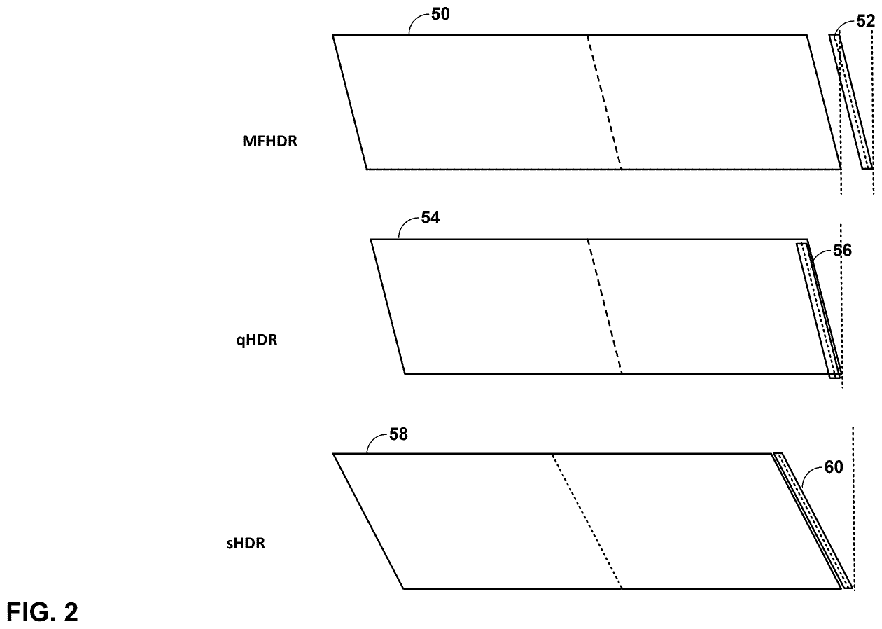

FIG. 2 shows example readouts for three multi-frame HDR image capture techniques. The top portion of FIG. 2 shows a multi-frame HDR (MFHDR) longer exposure image 50 and an MFHDR shorter exposure image 52. The dashed lines in each of the images represents the average capture time of the image. The images shown in FIG. 2 are depicted as parallelograms since they are captured using a rolling shutter. A rolling shutter in an image sensor captures an image by sequentially exposing each row of pixels to light, starting from the top row and moving to the bottom, rather than capturing the entire frame simultaneously. As such, the X-axis of each image in FIG. 2 represents time, while the Y-axis represents a row of the image sensor. As shown in FIG. 2, the first row of MFHDR longer exposure image 50 (e.g., the upper left corner) is captured before the last row of MFHDR longer exposure image 50 (e.g., the lower left corner).

MFHDR image capture is a technique used to create images with a greater range of luminance levels than what is possible with standard digital imaging. This method involves capturing multiple images of the same scene at different exposure levels and then combining them to produce a single image that represents the full range of luminance present in the scene. The primary goal of MFHDR is to accurately capture both the bright and dark areas of a scene without losing detail in either.

In MFHDR, the process typically begins by taking a series of images with varying exposure times. For instance, one image might be captured with a shorter exposure (e.g., MFHDR shorter exposure image 52) to preserve details in the bright areas, while another might use a longer exposure (e.g., MFHDR longer exposure image 50) to capture details in the darker regions. These images are then aligned and merged using specialized algorithms that blend the different exposures into a single HDR image. This blending process aims to minimize artifacts such as ghosting, which can occur when there is motion between the frames.

One of the challenges of MFHDR is managing the temporal mismatch between the longer and shorter exposures, as they are captured at different times, as shown in FIG. 2. This can lead to motion blur in the longer exposure and ghosting artifacts when the images are combined. To address these issues, advanced blending algorithms are employed to align and integrate the images accurately, even in dynamic scenes. In MFHDR techniques, the readout of MFHDR shorter exposure image 52 begins after the readout of MFHDR longer exposure image 50.

FIG. 2 also shows a quad high dynamic range (qHDR) mode that may be used to capture qHDR longer exposure image 54 and qHDR shorter exposure image 56. qHDR refers to a specific mode or technique designed to capture HDR images with certain constraints and characteristics. The qHDR mode involves capturing images with a single readout for both longer and shorter exposures, where both exposures overlap. This approach typically results in a lower resolution for each exposure compared to other HDR techniques. The qHDR mode aims to simplify the HDR capture process by reducing the complexity associated with multiple readouts, while still achieving an extended dynamic range. Relative to other HDR modes, there may be a loss of spatial resolution in the qHDR mode due to the overlapping exposures.

FIG. 2 also shows a staggered HDR (sHDR) mode that may be used to capture sHDR longer exposure image 58 and sHDR shorter exposure image 60. The sHDR mode involves an interleaved readout process, which results in double the readout time compared to other HDR techniques. This approach allows for capturing high-resolution images with enhanced dynamic range by interleaving the readout of longer and shorter exposures. The sHDR mode is designed to address the challenges of temporal mismatch between different exposures, better ensuring that both exposures are captured with the same resolution and timing, thereby reducing artifacts such as ghosting and motion blur. In both qHDR, and sHDR, readout time is interleaved for both shorter and longer exposures. However, since the integration time is different, on the end of the exposure is close in time. The longer exposure includes information from times not covered by the shorter exposure. As shown in FIG. 2, the readout time of sHDR is longer compared to other HDR techniques. The shorter exposure readout happens slightly after the long readout.

Regardless of the multi-frame HDR technique being used, there is typically some level of temporal mismatch between the longer and shorter exposures, thus resulting in ghosting and other motion artifacts. This disclosure describes an apparatus and method for reducing artifacts, including ghosting, during HDR capture. The techniques of this disclosure include an HDR capture mode used with a CAPD image sensor. As one example this disclosure describes changes to the operation of the CAPD image sensor that allows the capture of both longer exposure and shorter exposure images at approximately the same time. Since both the longer exposure image and the shorter exposure image are integrated over the same time, there is little to no temporal mismatch between the images. As such, each image will exhibit the same blurring, if any. Further, the combined HDR image formed from the longer exposure image and shorter exposure image may exhibiting fewer to no ghosting artifacts.

Returning to FIG. 1, in one example, camera processor 14 and/or processing circuitry on board sensor module 12 an image sensor may be configured to receive an indication to capture an image using an HDR capture mode. The indication may be automatically determined by camera processor 14 and/or sensor module 12 (e.g., based on lighting conditions) or may be a user-selectable mode of a user of computing device 10. In response to the HDR capture mode, camera processor 14 and/or processing circuitry on board sensor module 12 may cause a CAPD sensor of sensor module 12 to modulate a voltage at a modulation electrode of the CAPD sensor with an adjustable duty cycle (e.g., rather than a 50 percent duty cycle used for iTOF applications). In some examples, the adjustable duty cycle may be an asymmetric duty cycle. As opposed to iTOF applications, where the 50 percent duty cycle may be on the order of megahertz in frequency, the adjustable duty cycle for HDR image capture may be on the order of kilohertz. The adjustable duty cycle may be configured to cause a first photodiode of a pixel of the CAPD sensor to have a longer integration time relative to a second photodiode of the same pixel of the CAPD sensor. That is, one photodiode of the same pixel will receive light for a longer period of time than a second photodiode of the same pixel. Such modulation may be done for every CAPD pixel or a subset of CAPD pixels, as will be explained in more detail below. This adjustable duty cycle results in a longer exposure image being captured by the first photodiodes and a shorter exposure image being captured by the second photodiodes at the same time. Camera processor 14 may then receive image data for the image captured with the HDR mode. Camera processor 14 may combine the longer exposure image and the shorter exposure image to form an HDR image. Any technique may be used for blending the longer exposure image and the shorter exposure image to form the HDR image.

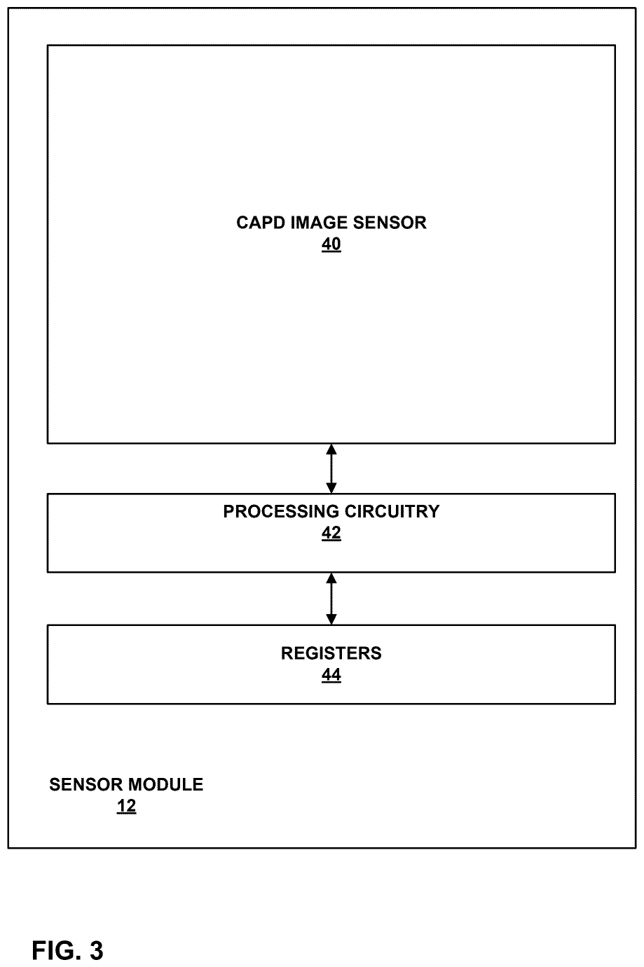

FIG. 3 is a block diagram of an example sensor module according to the techniques of this disclosure. Sensor module 12, as illustrated in FIG. 3, comprises several components that work together to achieve HDR capture in an image sensor with fewer ghosting artifacts. These components include CAPD image sensor 40, processing circuitry 42, and registers 44. CAPD image sensor 40 contains an array of photodiodes that convert incident light into electrical signals. Each pixel of CAPD image sensor 40 may include two photodiodes, with circuitry configured to direct light, alternatingly, two each of the two photodiodes of each pixel based on a voltage modulated at a modulation electrode.

Processing circuitry 42 (or camera processor 14 of FIG. 1), may cause CAPD image sensor 40 to generate a modulation voltage with an adjustable duty cycle for the pixels of CAPD image sensor 40, such that the two electrodes of a particular pixel in the image sensor capture images with different integration times (e.g., a longer integration time and a shorter integration time). Longer and shorter integration times are synonymous with longer and shorter exposure times. As one example, the adjustable duty cycle may be an asymmetric duty cycle. An asymmetric duty cycle for an electrical signal refers to a waveform where the time duration of the signal being in the “on” state (high) is different from the time duration of the signal being in the “off” state (low) within one complete cycle. This results in a duty cycle that is not 50%, allowing for control over the relative time spent in each state, which can be used to modulate the behavior of electronic components, such as varying the integration times of photodiodes in an image sensor. In the context of CAPD image sensor 40, the “on” state may of the signal may direct light to the first photodiode, while the “off” state of the signal may direct light to the second photodiode.

As will be described below, processing circuitry 42 may generate the modulation voltage with the adjustable duty cycle for all of the pixels of CAPD image sensor 40 or for a subset of the pixel sensors of CAPD image sensor 40. Each photodiode in CAPD image sensor 40 accumulates charge proportional to the intensity and duration of the incident light during the integration time. CAPD image sensor 40 can be configured in either a three transistor (3T) or four transistor (4T) pixel architecture, depending on the specific implementation.

As described above, processing circuitry 42 may receive an indication to capture an image using HDR capture mode. Such an indication may be stored in registers 44. In some examples, registers 44 may include a specific register that indicates to processing circuitry 42 to use the HDR capture mode. Registers 44 may further include a register that indicates the integration time, adjustable duty cycle, or other control parameters and settings used by the processing circuitry 42 to manage the HDR capture mode and/or other modes of CAPD image sensor 40. For example, registers 44 may include values for the specific adjustable duty cycle to use when operating the CAPD image sensor 40 in the HDR capture mode. Different duty cycles may result in different longer and shorter exposure times. In general, the ratio of “on” and “off” states during the adjustable duty cycle represent the ratio of longer and shorter integration times. Registers 44 allow for programmable control of the CAPD image sensor 40, enabling adjustments to be made based on specific requirements or user input. Processing circuitry 42 accesses the registers 44 to retrieve the parameters and apply them during the HDR image capture process.

As one example, camera processor 14 of FIG. 1 may be configured to set the values of registers 44 based on an automatic exposure control (AEC) algorithm. Camera processor 14 may measure the ambient light conditions using a light meter or by analyzing the initial frames captured by CAPD image sensor 40. Camera processor 14 assesses the overall brightness and contrast of the scene to understand the lighting environment. Based on this initial light measurement, camera processor 14 calculates the optimal exposure settings, determining the appropriate adjustable duty cycle that will result in optimal longer and shorter integration times to ensure proper exposure.

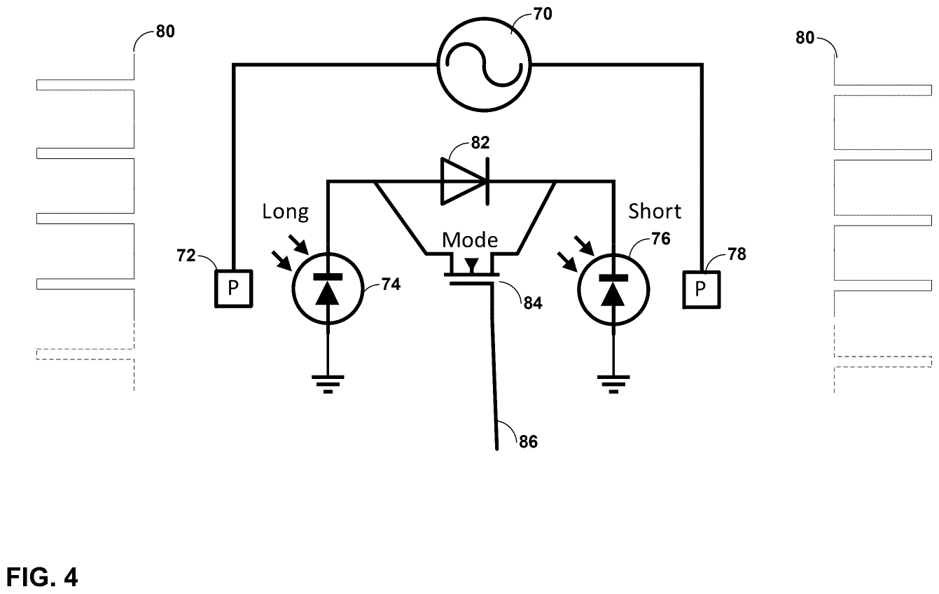

FIG. 4 is a circuit diagram showing an example pixel of a CAPD image sensor in accordance with the techniques of this disclosure. FIG. 4 presents a simplified version of a single pixel of a CAPD sensor, demonstrating the operation for capturing an HDR image. The pixel comprises a modulation electrode 70, which applies a modulated voltage 80, having an adjustable duty cycle, to manage the operation of the pixel. This modulated voltage 80 creates the electric fields used to direct photo-generated electrons within the pixel. Since modulated voltage 80 has an adjustable duty cycle (e.g., an asymmetric duty cycle), more light is directed toward one of the photodiodes compared to the other.

The pixel includes two photodiodes: a first photodiode 74 and a second photodiode 76. The first photodiode 74 is linked to a first detection electrode 72, while the second photodiode 76 is linked to a second detection electrode 78. These photodiodes are designed to capture light and convert light into electrical signals, with the first photodiode 74 generally having a longer integration time compared to the second photodiode 76 due to the adjustable duty cycle of modulated voltage 80. This allows for the capture of both longer and shorter exposures at the same time. As such, any blurring or smearing the longer and shorter exposures captured by the two photodiodes will be roughly the same. As such, when the two exposures are combined to form an HDR image, ghosting and other artifacts may be reduced.

In some optional examples, a diode 82 may be positioned between the first photodiode 74 and the second photodiode 76. Diode 82 serves to block charge flow from the first photodiode 74 to the second photodiode 76, preventing blooming effects when the first photodiode 74 becomes saturated. This configuration better ensures that the integrity of the captured image is maintained, even under varying lighting conditions.

In some other optional examples, the pixel may also include a mode switch 84, which is controlled by a mode switch control 86. The mode switch 84 enables the pixel to toggle between different operational modes, such as switching to a regular CAPD mode for iTOF applications, and the HDR capture mode of this disclosure. As one example, mode switch 84 may disconnect diode 82 for iTOF applications. This adaptability in operation may allow for the adjustment of the sensor to various imaging requirements, enhancing its usefulness in a range of applications.

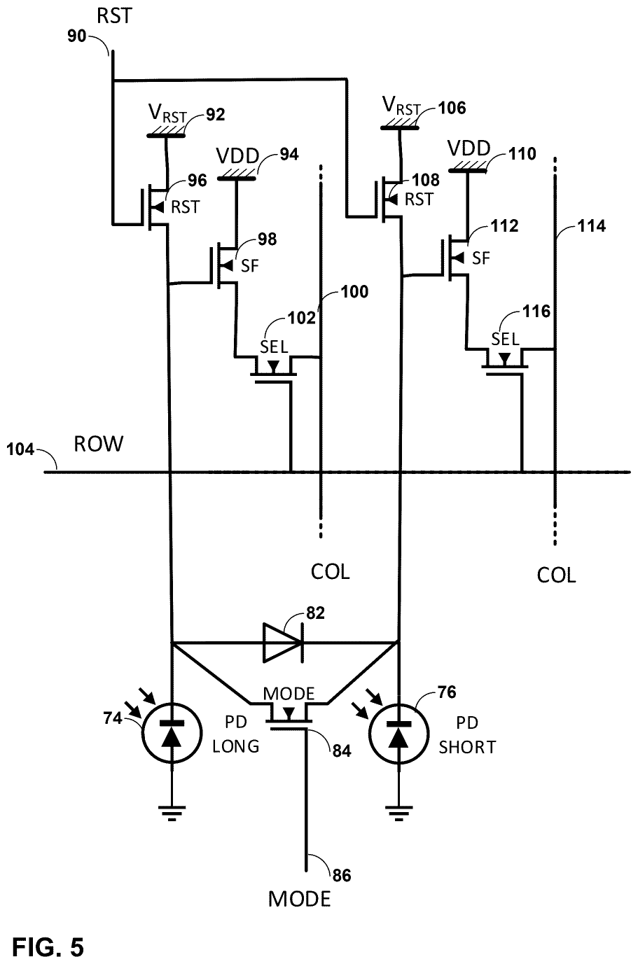

FIG. 5 is a circuit diagram showing another example pixel of a CAPD image sensor in accordance with the techniques of this disclosure. In particular, FIG. 5 shows a circuit diagram for an example pixel of a CAPD image sensor with a 3 transistor (3T) circuit configuration. Like FIG. 4, the pixel includes a first photodiode 74 and a second photodiode 76. The first photodiode 74 is responsible for capturing longer exposure images, while the second photodiode 76 captures shorter exposure images. This dual photodiode setup allows for simultaneous capture of different exposure levels.

VDD 94 and VDD 110 are the supply voltages for the readout circuitry for first photodiode 74 and second photodiode 76, respectively. VDD 94 and VDD 110 provides the power for the operation of the source follower (SF) transistors 98 and 112, and other components in 3T pixel architecture.

COL 100 and COL 114 represents the column line in the image sensor array. COL 100 is used to read out the signal from first photodiode 74 after the integration period. Likewise, COL 114 is used to read out the signal from second photodiode 76 after the integration period. The signal on COL 100 and COL 114 is influenced by the amount of charge accumulated their respective photodiodes. COL 100 is connected to SF 98 (e.g., through row select (SEL) transistor 102), which buffers the signal before processing circuitry 42 (see FIG. 3) reads out the signal. COL 114 is connected to SF 112 (e.g., through SEL 116)

SF 98 is the source follower transistor that buffers the signal from first photodiode 74 before the signal is read out on COL 100. SF 98 provides a high input impedance and low output impedance, ensuring that the signal from first photodiode 74 is accurately transferred to COL 100. Likewise, SF 112 is the source follower transistor that buffers the signal from second photodiode 76 before the signal is read out on COL 114

Row select transistor (SEL) 102 enables the readout of the signal from first photodiode 74. Likewise, SEL 116 enables the readout of the signal from second photodiode 76. SEL 102 and SEL 116 are activated by the row select signal, allowing the buffered signal from SF 98 and SF 112 to be transferred to the COL 100 and COL 114, respectively. The operation of SEL 102 and SEL 116 are synchronized with the readout process, ensuring that the correct pixel signals are read out at the appropriate times.

ROW 104 represents the row line in the image sensor array. ROW 104 is used to select the specific row of pixels to be read out. ROW 104 controls the activation of SEL 102 and SEL 116, enabling the readout of the signal from first photodiode 74 and second photodiode 76 in the selected row. ROW 104 is part of the overall addressing scheme that allows for the sequential readout of pixel signals from the image sensor array.

RST 96 and RST 108 are the reset transistors that controls the application of the reset voltage to first photodiode 74 and second photodiode 76, respectively. RST 96 is activated by RST voltage 90, allowing V_{RST} 92 to reset first photodiode 74. Likewise, RST 108 is activated by RST voltage 90, allowing V_{RST} 106 to reset second photodiode 76.

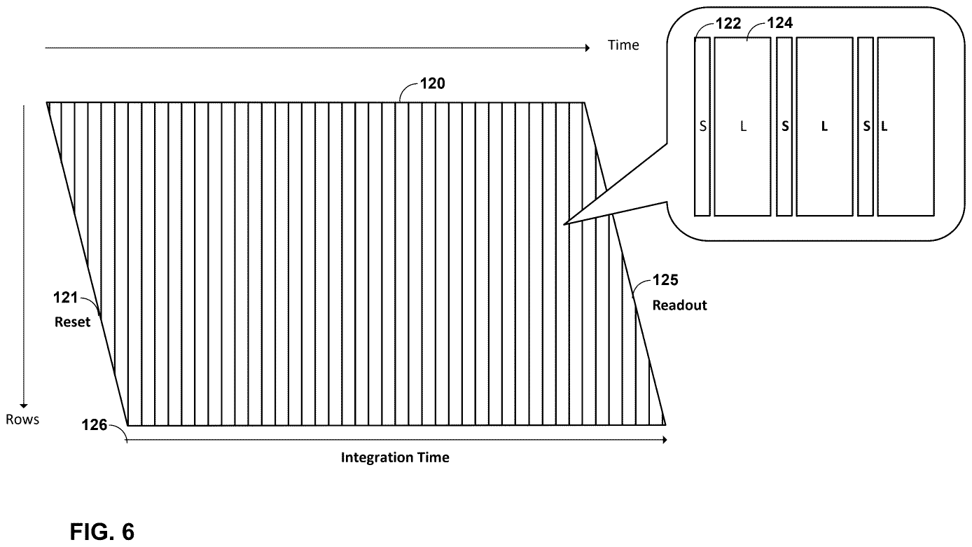

FIG. 6 shows an example readout time for the CAPD HDR technique of this disclosure. FIG. 6 shows a readout diagram illustrating a combined HDR exposure 120, which is composed of a series of shorter exposures 122 and longer exposures 124. FIG. 6 represents the capture of a single frame using the HDR CAPD image sensor techniques of this disclosure. HDR exposure 120 shows the integration time 126 in the X-axis, with the rows of the pixel sensor in the Y-axis. Reset 121 represents the time at which the photodiodes for each row are reset. Readout 125 represents the time at which the voltage at each of the photodiodes are read. The combined HDR exposure 120 is achieved through the modulation of voltage at the modulation electrode of the CAPD sensor with an adjustable duty cycle. This modulation results in alternating time slices of shorter exposure captures 122 and longer exposure captures 124.

The shorter exposures 122 are designed to capture details in the brighter areas of a scene, while the longer exposures 124 are intended to capture details in the darker regions. By alternating between these two types of exposures, the system effectively captures a wide range of luminance levels within a single frame. This approach mitigates the common issues associated with traditional HDR techniques, such as ghosting and motion blur, by ensuring that both shorter and longer exposures are captured simultaneously.

The significance of this configuration lies in the ability to reduce temporal mismatches between different exposure captures, which is a common problem in conventional HDR imaging systems. By capturing both shorter and longer exposures simultaneously, the system better ensures that any motion present in the scene affects both exposures equally, thereby reducing artifacts in the final HDR image. This method enhances the overall image quality and provides a more efficient HDR image capture process, while also simplifying the sensor architecture and potentially reducing power consumption.

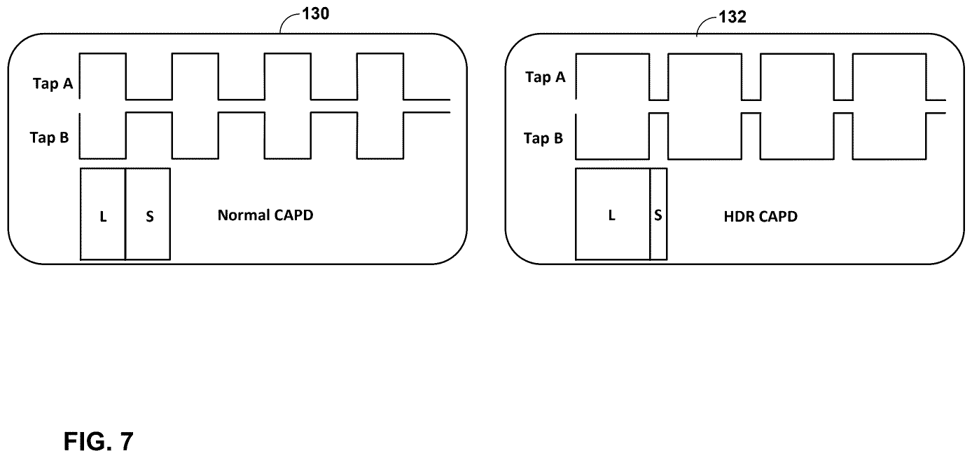

FIG. 7 shows an example duty cycle for the CAPD HDR technique of this disclosure. FIG. 7 illustrates a standard duty cycle 130 and an asymmetric duty cycle 132, each serving distinct purposes in the context of image capture. The typical duty cycle 130 represents the standard operation of a CAPD sensor, often used in iTOF applications. In this configuration, the duty cycle is set at 50 percent, meaning that the time allocated for the “on” state is equal to the “off” state within one complete cycle. This balanced duty cycle is suitable for iTOF applications where consistent exposure times are used for accurate distance measurement. In this setup, Tap A corresponds to the first photodiode, and Tap B corresponds to the second photodiode of the same pixel, with both photodiodes receiving equal exposure time.

The asymmetric duty cycle 132, on the other hand, is specifically designed for HDR image capture. This duty cycle deviates from the 50 percent balance, allowing for different integration times for the two photodiodes within a pixel. In this configuration, Tap A, the first photodiode, is designated for longer exposure (L), while Tap B, the second photodiode, is designated for shorter exposure (S). The asymmetric duty cycle enables the simultaneous capture of longer and shorter exposures, which is beneficial for HDR imaging as the simultaneous capture helps to mitigate issues such as ghosting and motion blur by ensuring that both exposures are captured with the same temporal characteristics.

Note that in some examples, the adjustable duty cycle of this disclosure may not necessarily be asymmetric. Rather, the adjustable duty cycle may be configured to cause two photodiodes of the same pixel to capture light with different integration times. In some examples, the two photodiodes may be of different sizes (e.g., in a big/small configuration), such that an adjustable duty cycle may cause one photodiode of the pixel (e.g., the “big” photodiode) to capture more light compared to the other photodiode of the pixel (e.g., the “small” photodiode). In this context, “big” and “small” refer to the relative sizes of the two photodiodes in terms of area.

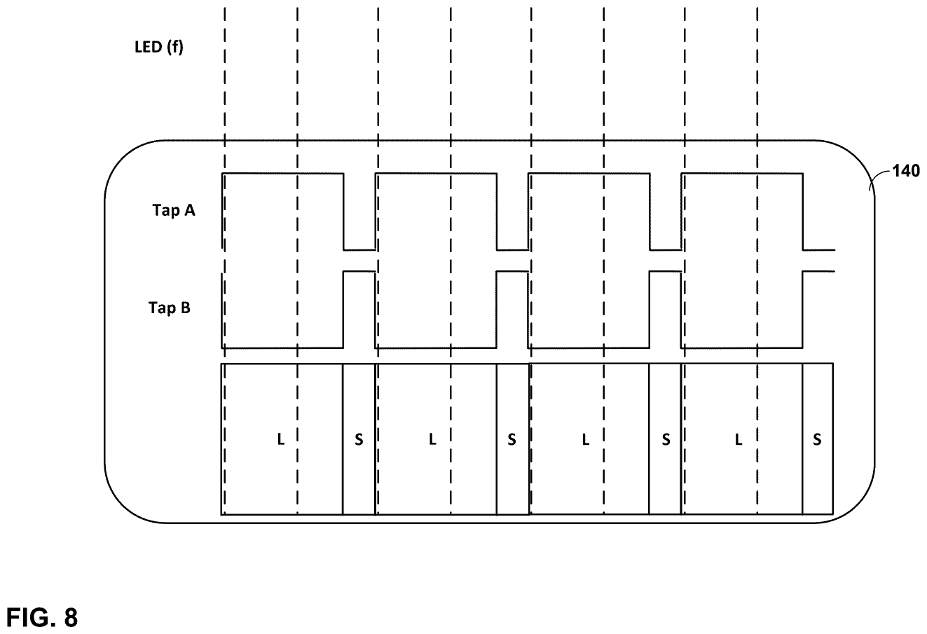

FIG. 8 shows another example duty cycle for the CAPD HDR technique of this disclosure. The asymmetric duty cycle 140 modulates the voltage at the modulation electrode of the CAPD sensor, enabling different integration times for the two photodiodes within a pixel. This modulation achieves the simultaneous capture of longer and shorter exposures. In this configuration, the asymmetric duty cycle 140 is designed so that the first photodiode, referred to as Tap A, is designated for longer exposure (L), while the second photodiode, Tap B, is designated for shorter exposure (S). The modulation of the duty cycle ensures that the longer exposure photodiode receives more light over a longer period, while the shorter exposure photodiode receives less light over a shorter period. This setup allows for the capture a wide range of luminance levels within a single frame, thereby enhancing the dynamic range of the captured image.

FIG. 8 also illustrates the interaction between the CAPD sensor and an LED light source from the scene, denoted as LED (f). The modulation of the LED signal may not be synchronized with the CAPD sensor, which can lead to flicker in some circumstances. This flicker occurs because the shorter exposure photodiode may not receive the signal from the LED, depending on the phase of the LED modulation relative to the duty cycle.

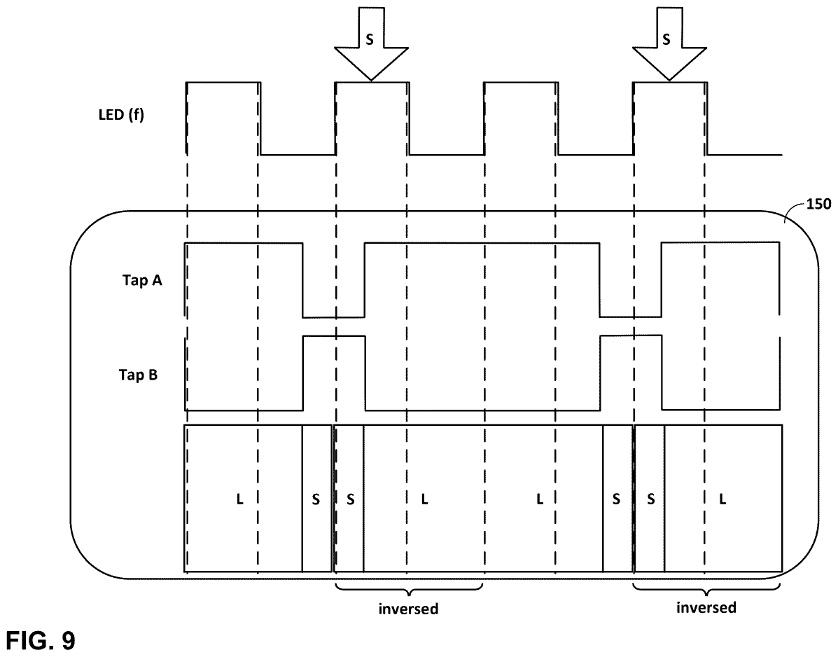

FIG. 9 shows an example duty cycle with a random inverse phase function for the CAPD HDR technique of this disclosure. In particular, FIG. 9 shows a pseudo-random asymmetric duty cycle 150, which is designed to mitigate LED flicker issues that may arise from the fixed asymmetric duty cycle depicted in FIG. 8. The pseudo-random asymmetric duty cycle 150 is configured to maintain the same ratio between longer and shorter exposures as a fixed asymmetric duty cycle, but with the added benefit of reducing flicker problems. In FIG. 9, the arrows marked “S” indicate that the shorter exposure photodiode can receive light. In FIG. 8, the shorter exposure photodiode cannot receive light during the entire exposure period. As such, the pseudo-random code in FIG. 9 may improve flicker.

The pseudo-random asymmetric duty cycle 150 is applied to the modulation of the CAPD sensor, specifically affecting the integration times of the photodiodes within a pixel. In this configuration, the duty cycle is not fixed but varies in a pseudo-random manner, which helps distribute the light exposure more evenly over time relative to LED (f). This distribution plays an important role in environments where LED lighting is used, as it can prevent the flicker that typically occurs when the LED's modulation frequency interacts with the fixed duty cycle of the sensor.

The pseudo-random nature of the duty cycle ensures that the exposure times for the photodiodes, referred to as Tap A and Tap B, are varied in a way that mitigates the effects of LED flicker. Tap A is designated for longer exposure (L), while Tap B is designated for shorter exposure (S). The pseudo-random modulation allows for the shorter exposure photodiode to occasionally receive the LED signal, which is otherwise missed in a fixed duty cycle setup. This is achieved through the use of a random inverse phase function, which inverts the phase of the duty cycle at pseudo-random intervals.

The implementation of the pseudo-random asymmetric duty cycle 150 provides an advantage in maintaining image quality in HDR imaging by reducing artifacts associated with LED flicker. This approach enhances the dynamic range of the captured image while ensuring that both longer and shorter exposures are captured with consistent temporal characteristics, thereby improving the overall performance of the CAPD sensor in varied lighting conditions.

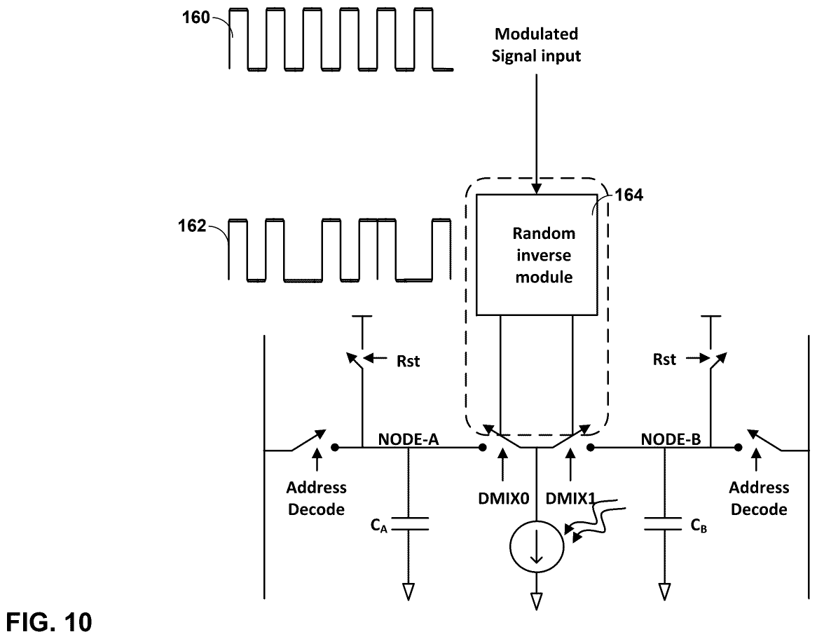

FIG. 10 is a circuit diagram showing an HDR CAPD pixel with a random inverse phase function for the CAPD HDR technique of this disclosure. In particular, FIG. 10 presents a conceptual circuit diagram for generating the pseudo-random duty cycle for a CAPD sensor, as depicted in FIG. 9. FIG. 10 illustrates the integration of a modulated signal input 160, a pseudo-random asymmetric duty cycle 162, and a random inverse module 164, which may be implemented to achieve the desired modulation for HDR imaging in a CAPD sensor with LED flicker mitigation.

The modulated signal input 160 serves as the initial input to the system, providing the signal that will be processed to achieve the pseudo-random duty cycle. This input forms the basis for the modulation process that will be applied to the CAPD sensor. The pseudo-random asymmetric duty cycle 162 represents the modulation pattern that will be applied to the CAPD sensor. This duty cycle is characterized by a pseudo-random nature, which aids in distributing light exposure more evenly over time, thereby mitigating issues such as LED flicker that can occur with fixed duty cycles.

The random inverse module 164 generates the pseudo-random nature of the duty cycle. This module processes the modulated signal input 160 to produce a duty cycle that varies in a pseudo-random manner. This variation better ensures that the exposure times for the photodiodes within the CAPD sensor are adjusted in a way that reduces artifacts associated with LED flicker, thereby enhancing the overall image quality in HDR imaging.

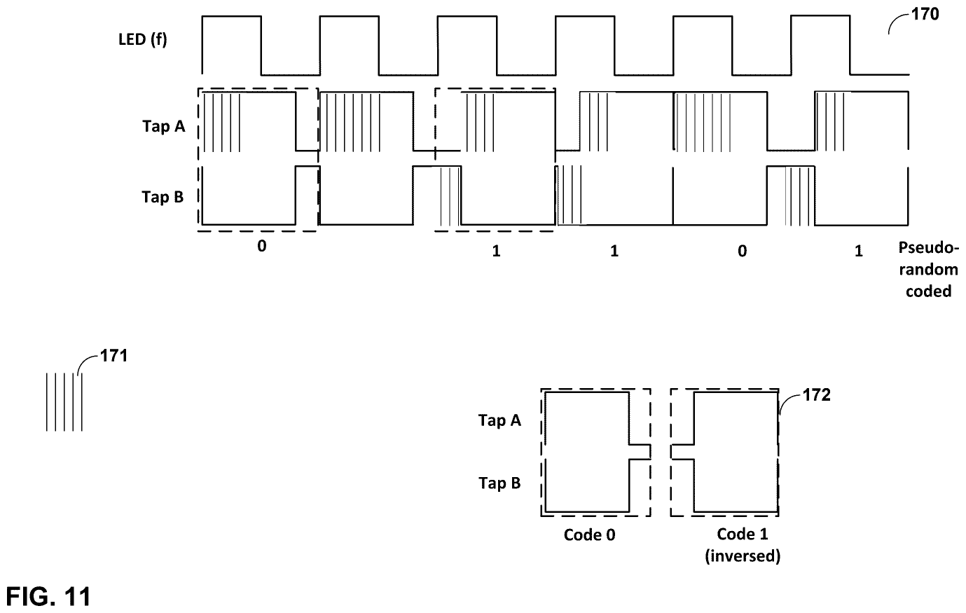

FIG. 11 shows another example duty cycle with a random inverse phase function for the CAPD HDR technique of this disclosure. FIG. 11 illustrates an asymmetric duty cycle 170, which is pseudo-randomly coded to improve the performance of a CAPD image sensor during HDR capture. The asymmetric duty cycle 170 is designed to modulate the voltage at the modulation electrode of the CAPD sensor, allowing for different integration times for the two photodiodes within a pixel, referred to as Tap A and Tap B. The shaded areas 171 indicate the light received. The shaded areas 171 are alighted with the LED signal, but will be collected by either the longer exposure (L) photodiode (Tap A) or the shorter exposure (s) photodiode (Tap B) according to the pseudo-random code.

The pseudo-random coding of the asymmetric duty cycle 170 addresses challenges, such as LED flicker, that can arise with fixed duty cycles. By altering the duty cycle in a pseudo-random fashion, the system adjusts the exposure times for the photodiodes in a manner that diminishes artifacts linked to LED flicker. This technique improves the dynamic range of the captured image while preserving uniform temporal characteristics for both extended and brief exposures.

A specific segment 172 of the asymmetric duty cycle 170 is highlighted, illustrating an example of a typical pulse (code 0) and an inversed pulse (code 1). This segment 172 demonstrates how the pseudo-random coding is implemented, with the typical pulse representing the standard operation and the inversed pulse providing the variation needed to achieve the desired modulation effect. The use of pseudo-random coding ensures that the total number of typical and inversed pulses is balanced, distributing the light exposure more evenly over time and improving the overall image quality in varied lighting conditions.

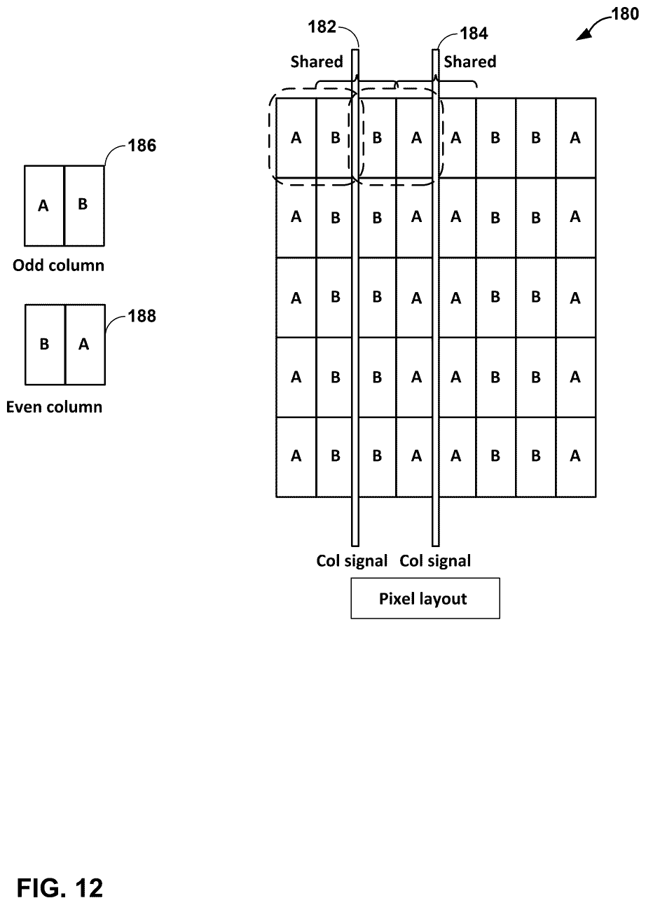

FIG. 12 shows an example readout trace implementation in accordance with one example of the disclosure. FIG. 12 shows a sensor portion 180 of a CAPD image sensor, illustrating a pixel layout that optimizes the use of output traces for HDR imaging. The layout features first photodiodes labeled A and second photodiodes labeled B, which are arranged in an alternating pattern across odd column pixels 186 and even column pixels 188. This configuration allows for the efficient sharing of output traces between adjacent pixels.

In this arrangement, the first photodiodes A are designated for longer exposure, while the second photodiodes B are designated for shorter exposure, or vice versa. The alternating pattern enables two first photodiodes of adjacent pixels to share the same longer exposure trace 184, and similarly, two second photodiodes of adjacent pixels share the same shorter exposure trace 182. This shared trace configuration significantly reduces the number of metal lines required in the sensor, effectively halving the number of output traces needed compared to traditional designs.

The technical advantage of this layout is the reduction in complexity and material usage in the CAPD image sensor, which can lead to lower production costs and potentially enhanced performance due to reduced electrical interference. By minimizing the number of metal lines, the design also allows for a more compact sensor architecture, which is beneficial for integrating the sensor into smaller devices without compromising on image quality or dynamic range capabilities.

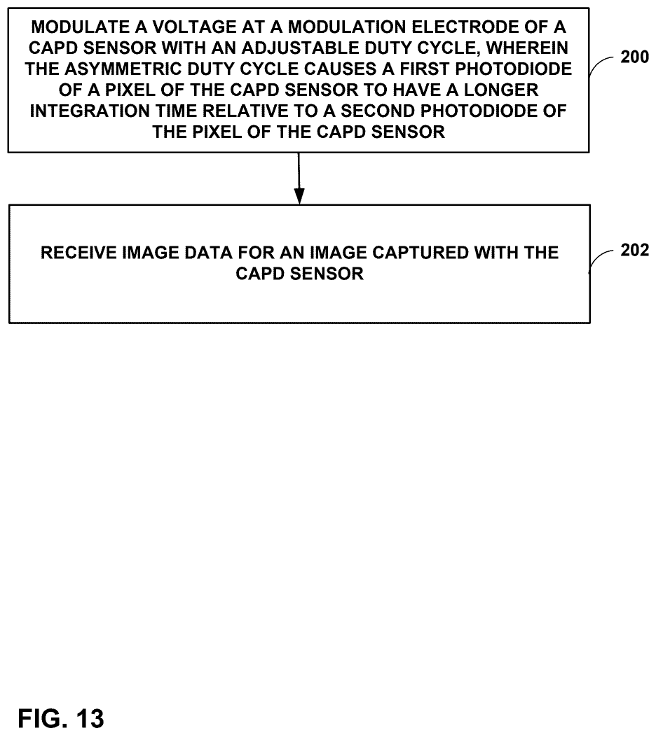

FIG. 13 illustrates a flow chart illustrating an example process for capturing an image using an HDR capture mode according to the techniques of this disclosure. The techniques of FIG. 13 may be performed by one or more of processing circuitry 42 of FIG. 3 or camera processor 14 of FIG. 1. As shown in FIG. 13, processing circuitry 42 of sensor module 12 may be configured to modulate a voltage at a modulation electrode of a CAPD sensor with an adjustable duty cycle, wherein the adjustable duty cycle causes a first photodiode of a pixel of the CAPD sensor to have a longer integration time relative to a second photodiode of the pixel of the CAPD sensor (200). In one example, such as shown in FIG. 6, the integration time is a series of time slices for the first photodiode and the second photodiode. Processing circuitry 42 may be further configured to receive image data for an image captured with the CAPD sensor (202). In one example, the image data includes a longer exposure image from the first photodiode and a shorter exposure image from the second photodiode. In this example, processing circuitry 42 may be further configured to combine the longer exposure image and the shorter exposure image to form an HDR image. Any techniques for combining longer exposure and shorter exposure images to form an HDR image may be used.

In one example of the disclosure, to modulate a voltage at the modulation electrode of the CAPD sensor with the adjustable duty cycle, processing circuitry 42 may be configured to apply a random inverse phase function to the voltage. The random inverse phase function may cause the adjustable duty cycle to be pseudo-random, as described above.

In some examples, the CAPD sensor may operate only according to an HDR mode. In other examples, processing circuitry 42 may be configured to cause the CAPD sensor to operate in one of a plurality of modes. Processing circuitry may automatically determine a mode, or may receive an indication (e.g., from a user) of which capture mode to use. As one example, processing circuitry 42 may be configured to automatically determine to use an HDR mode based on current lighting conditions of a scene. Accordingly, in another example of the disclosure, processing circuitry 42 may be configured to operate in a standard dynamic range (SDR) mode, and then determine to switch to an HDR mode. Processing circuitry 42 may then, in response to switching to the HDR mode, modulate the voltage at the modulation electrode of the CAPD sensor with the adjustable duty cycle.

In another example of the disclosure, the pixel of the CAPD sensor further includes a diode between the first photodiode and the second photodiode, the diode being configured to block charge from flowing from the first photodiode to the second photodiode. Further in this example, the pixel of the CAPD sensor may further include a switch configured to activate the diode when the CAPD sensor is in the HDR mode and configured to bypass the diode when the CAPD sensor is not in the HDR mode. In still another example of the disclosure, two photodiodes of adjacent pixels of the CAPD sensor may share the same readout trace.

The techniques described above for using an adjustable duty cycle in a CAPD sensor for HDR image capture may be applied to every pixel of a CAPD image sensor. In other examples, the techniques of this disclosure may be applied to a subset of pixels of CAPD image sensor, such as in a Bayer filter pattern, interleaved rows, interleaved columns or checkerboard patterns. In some examples, the CAPD sensor may include a first plurality of pixels configured for indirect Time-of-Flight (iTOF) image capture, and a second plurality of pixels configured for HDR image capture. In other examples, the CAPD sensor includes a first plurality of pixels configured for infrared image capture, and a second plurality of pixels configured for RGB image capture.

The following describes one or more examples in accordance with the techniques described in this disclosure.
Aspect 1. An apparatus configured to capture an image, the apparatus comprising: a memory; and processing circuitry coupled to the memory, the processing circuitry configured to: modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and receive image data for an image captured with the CAPD sensor.
Aspect 2. The apparatus of Aspect 1, wherein the integration time is a series of time slices for the first photodiode and the second photodiode.
Aspect 3. The apparatus of any of Aspects 1-2, wherein the image data includes a longer exposure image from the first photodiode and a shorter exposure image from the second photodiode, and wherein the processing circuitry is further configured to: combine the longer exposure image and the shorter exposure image to form an HDR image.
Aspect 4. The apparatus of any of Aspects 1-3, wherein to modulate a voltage at the modulation electrode of the CAPD sensor with the adjustable duty cycle, the processing circuitry is further configured to: apply a random inverse phase function to the voltage.
Aspect 5. The apparatus of any of Aspects 1-4, wherein the processing circuitry is further configured to: operate in a standard dynamic range (SDR) mode; determine to switch to a high dynamic range (HDR) mode; and modulate the voltage at the modulation electrode of the CAPD sensor with the adjustable duty cycle in response to the switch to the HDR mode.
Aspect 6. The apparatus of any of Aspects 1-5, wherein the pixel of the CAPD sensor further includes a diode between the first photodiode and the second photodiode, the diode being configured to block charge from flowing from the first photodiode to the second photodiode.
Aspect 7. The apparatus of Aspect 6, wherein the pixel of the CAPD sensor further includes a switch configured to activate the diode when the CAPD sensor is in the HDR mode and configured to bypass the diode when the CAPD sensor is not in the HDR mode.
Aspect 8. The apparatus of any of Aspects 1-7, wherein two photodiodes of adjacent pixels of the CAPD sensor share the same readout trace.
Aspect 9. The apparatus of any of Aspects 1-8, further comprising the CAPD sensor.
Aspect 10. The apparatus of any of Aspects 1-9, wherein the CAPD sensor includes a first plurality of pixels configured for indirect Time-of-Flight (iTOF) image capture, and a second plurality of pixels configured for HDR image capture.
Aspect 11. The apparatus of any of Aspects 1-10, wherein the CAPD sensor includes a first plurality of pixels configured for infrared image capture, and a second plurality of pixels configured for RGB image capture.
Aspect 12. A method for capturing an image, the method comprising: modulating a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and receiving image data for an image captured with the CAPD sensor.
Aspect 13. The method of Aspect 12, wherein the integration time is a series of time slices for the first photodiode and the second photodiode.
Aspect 14. The method of any of Aspects 12-13, wherein the image data includes a longer exposure image from the first photodiode and a shorter exposure image from the second photodiode, and wherein the method further comprises: combining the longer exposure image and the shorter exposure image to form an HDR image.
Aspect 15. The method of any of Aspects 12-14, wherein modulating the voltage at the modulation electrode of the CAPD sensor with the adjustable duty cycle comprises: applying a random inverse phase function to the voltage.
Aspect 16. The method of any of Aspects 12-15, further comprising: operating in a standard dynamic range (SDR) mode; determining to switch to a high dynamic range (HDR) mode; and modulating the voltage at the modulation electrode of the CAPD sensor with the adjustable duty cycle in response to the switch to the HDR mode.
Aspect 17. The method of any of Aspects 12-16, wherein the pixel of the CAPD sensor further includes a diode between the first photodiode and the second photodiode, the diode being configured to block charge from flowing from the first photodiode to the second photodiode.
Aspect 18. The method of Aspect 17, wherein the pixel of the CAPD sensor further includes a switch configured to activate the diode when the CAPD sensor is in the HDR mode and configured to bypass the diode when the CAPD sensor is not in the HDR mode.
Aspect 19. The method of any of Aspects 12-18, wherein two photodiodes of adjacent pixels of the CAPD sensor share the same readout trace.
Aspect 20. A non-transitory computer-readable storage medium storing instructions that, when executed, cause one or more processors of a device configured to capture an image to: modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and receive image data for an image captured with the CAPD sensor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to capture an image, the apparatus comprising:
a memory; and
processing circuitry coupled to the memory, the processing circuitry configured to:
modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and
receive image data for the image captured with the CAPD sensor.

2. The apparatus of claim 1, wherein the integration time is a series of time slices for the first photodiode and the second photodiode.

3. The apparatus of claim 1, wherein the image data includes a longer exposure image from the first photodiode and a shorter exposure image from the second photodiode, and wherein the processing circuitry is further configured to:
combine the longer exposure image and the shorter exposure image to form an HDR image.

4. The apparatus of claim 1, wherein to modulate a voltage at the modulation electrode of the CAPD sensor with the adjustable duty cycle, the processing circuitry is further configured to:
apply a random inverse phase function to the voltage.

5. The apparatus of claim 1, wherein the processing circuitry is further configured to:
operate in a standard dynamic range (SDR) mode;
determine to switch to a high dynamic range (HDR) mode; and
modulate the voltage at the modulation electrode of the CAPD sensor with the adjustable duty cycle in response to the switch to the HDR mode.

6. The apparatus of claim 5, wherein the pixel of the CAPD sensor further includes a diode between the first photodiode and the second photodiode, the diode being configured to block charge from flowing from the first photodiode to the second photodiode.

7. The apparatus of claim 6, wherein the pixel of the CAPD sensor further includes a switch configured to activate the diode when the CAPD sensor is in an HDR mode and configured to bypass the diode when the CAPD sensor is not in the HDR mode.

8. The apparatus of claim 1, wherein two photodiodes of adjacent pixels of the CAPD sensor share a same readout trace.

9. The apparatus of claim 1, further comprising the CAPD sensor.

10. The apparatus of claim 1, wherein the CAPD sensor includes a first plurality of pixels configured for indirect Time-of-Flight (iTOF) image capture, and a second plurality of pixels configured for HDR image capture.

11. The apparatus of claim 1, wherein the CAPD sensor includes a first plurality of pixels configured for infrared image capture, and a second plurality of pixels configured for RGB image capture.

12. A method for capturing an image, the method comprising:
modulating a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and
receiving image data for the image captured with the CAPD sensor.

13. The method of claim 12, wherein the integration time is a series of time slices for the first photodiode and the second photodiode.

14. The method of claim 12, wherein the image data includes a longer exposure image from the first photodiode and a shorter exposure image from the second photodiode, and wherein the method further comprises:
combining the longer exposure image and the shorter exposure image to form an HDR image.

15. The method of claim 12, wherein modulating the voltage at the modulation electrode of the CAPD sensor with the adjustable duty cycle comprises:
applying a random inverse phase function to the voltage.

16. The method of claim 12, further comprising:
operating in a standard dynamic range (SDR) mode;
determining to switch to a high dynamic range (HDR) mode; and
modulating the voltage at the modulation electrode of the CAPD sensor with the adjustable duty cycle in response to the switch to the HDR mode.

17. The method of claim 16, wherein the pixel of the CAPD sensor further includes a diode between the first photodiode and the second photodiode, the diode being configured to block charge from flowing from the first photodiode to the second photodiode.

18. The method of claim 17, wherein the pixel of the CAPD sensor further includes a switch configured to activate the diode when the CAPD sensor is in the HDR mode and configured to bypass the diode when the CAPD sensor is not in the HDR mode.

19. The method of claim 12, wherein two photodiodes of adjacent pixels of the CAPD sensor share a same readout trace.

20. A non-transitory computer-readable storage medium storing instructions that, when executed, cause one or more processors of a device configured to capture an image to:
modulate a voltage at a modulation electrode of a current assisted photonic demodulator (CAPD) sensor with an adjustable duty cycle, wherein the adjustable duty cycle causes a first photodiode of a pixel of the CAPD sensor to have a longer integration time relative to a second photodiode of the pixel of the CAPD sensor; and
receive image data for the image captured with the CAPD sensor.
